(19) United States
(12) Patent Application Publication
(10) Pub. No.: US 2006/0004698 A1
(43) Pub. Date: Jan. 5, 2006

(54) Automated prioritization of user data files

(75) Inventors: Seppo Pyhalammi, Helsinki (FI); Kaj Haggman, Espoo (FI); Jouni Soitinaho, Espoo (FI); Tuomo Sihvola, Espoo (FI)

Correspondence Address: BANNER & WITCOFF, 1001 G STREET N W, SUITE 1100, WASHINGTON, DC, 20001, US

(73) Assignee: Nokia Corporation, Espoo (FI)

(21) Appl. No.: 10/879,132

(22) Filed: Jun. 30, 2004

(51) Int. Cl. G06F 7/00

(52) U.S. Cl. 707/2

(57) ABSTRACT

User data files for electronic images and/or other types of information are stored in a server coupled to a display such as a television set and having interfaces with one or more communication networks. Priorities of individual user data files are modified based on prior activity regarding those files. File activities affecting priority can include enlarging an image, editing an image and copying an image to another folder. When the user views an array of thumbnail images, thumbnail images are only displayed for user data files meeting a priority threshold. The user can adjust the priority threshold so as to increase or decrease the number of thumbnail images shown. The invention is applicable to numerous types of data, files and file formats, as well as to numerous manners of providing information regarding files.

### FIELD OF THE INVENTION

The present invention relates generally to organizing, maintaining and accessing electronic data. More particularly, the invention concerns organizing, accessing and/or maintaining electronic image and other types of user data so as to provide a more convenient way to browse, search and view electronically stored information.

### BACKGROUND OF THE INVENTION

Digital cameras and other devices for digital imaging, video recording and audio recording have become commonplace. For example, many wireless telephones and other mobile devices also create digital photographs, video segments and audio segments. The increasing ease with which users can create and store digital images creates challenges, however. Unlike conventional photography, where costs of film and developing tend to limit the number photographs created on a given occasion, electronic imaging encourages users to create a larger number of images. Because there are no film or developing costs involved, it is easier to generate multiple images. However, this advantage often comes at the cost of having to review and organize a much larger number of images. As more and more images accumulate, it becomes more and more difficult for a user to organize the images, as well as to find a particular stored image. In part because of the inconvenience and time required to organize these images into folders (or “albums”) and/or delete redundant and/or undesirable images, many users simply allow a large number of images (and/or video clips and/or audio clips) to accumulate.

When a user later wishes to locate one or more images, the user must often browse through a great number of images in order to find the material of interest. In many cases, the mobile device used to create the images automatically names each image file. However, those names are usually not descriptive of the image, and many users do not take the time to rename the image files. Accordingly, the user must then view the images themselves in order to find the desired material. In some cases, numerous smaller versions of those images (or “thumbnails”) can be arrayed on a display screen, thereby allowing the user to see multiple images at once. These thumbnails may sometimes be arranged chronologically, i.e., based on the dates of image creation. Although such an array is helpful in certain respects, thumbnail images are typically low resolution and not useful for seeing finer details. It is sometimes difficult to evaluate image quality from a thumbnail. Moreover, many images will often have very similar content (e.g., a user may have taken two or three images of persons posing for a photograph). Accordingly, the user is often required to sequentially select multiple thumbnail images for enlargement in order to find a single image of interest. This is often time-consuming and inconvenient.

Similar challenges exist with regard to other types of user data files. Throughout this specification (including claims), “user data file” also includes, but is not limited to, video files (e.g., MPEG and other file types), audio files (e.g., MP3, MIDI, WAV and other file types), text files, message files (e.g., SMS and MMS messages), e-mails, HTML files, presentations, etc. As with digital images, many wireless telephones and other types of portable devices have increased the ease with which various types of data files may be generated and/or retained. Users often accumulate large numbers of various types of files and want to save many of those files for future reference. As with image files, however, organizing these other file types can be a tedious process. Accordingly, many users fail to organize file collections, thereby increasing the difficulty when later searching for a desired file. For these and other reasons, there remains a need for systems and methods by which desired images and other types of user data can be more conveniently located.

### SUMMARY OF THE INVENTION

Aspects of the present invention are directed to allowing a user to locate user data files stored in a memory. User data files for electronic images and/or other types of information are stored in the memory and have priorities based on prior activity regarding those files. As used in this specification (including claims), a file “priority” generally refers to a manner of distinguishing a file from other files. A priority may be a value assigned to a file (e.g., in a table or other listing of files, or as an attribute or metadata included in the file itself). Priority also includes a file ranking without explicit assignment of a value to that file, such as by placing a file in a particular location within an ordered group of files. By way of example, file activities affecting image file priority can include enlarging an image, editing an image and copying an image to another folder. When the user views an array of thumbnail images in some embodiments, thumbnail images are only displayed for user data files meeting a priority threshold. The user can adjust the priority threshold so as to increase or decrease the number of thumbnail images shown.

In a first embodiment, the invention includes a method for providing information about user data files based on file priorities. A plurality of user data files are stored in a memory, each of the user data files having a priority. One or more file actions are performed with regard to one or more user data files of the plurality. The priorities of the user data files are modified in response to performance of those file actions. A designation of a priority threshold is received, and a determination made regarding which user data files have a priority above that threshold. Information is then provided about user data files of the plurality having a priority above the priority threshold. A second embodiment includes a machine-readable medium having instructions for performing a method similar to that of the first embodiment. A third embodiment includes a server or other electronic device having a processor configured to perform steps similar to those of the first embodiment.

These and other features of the invention will be apparent upon consideration of the following detailed description of preferred embodiments.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention.

FIG. 1 is a block diagram of an example of a wireless communication system in which various aspects of the present invention may be implemented.

FIG. 2 is a block diagram of an illustrative mobile device according to at least one embodiment of the invention.

FIG. 3 is a block diagram of a server according to at least one embodiment of the invention.

FIG. 4 shows, in partially schematic form and according to at least some embodiments of the invention, a thumbnail view of multiple images on a display, corresponding image files, and a table for data regarding the corresponding image files.

FIG. 5 shows, in partially schematic form and according to at least some embodiments of the invention, update of an image file table based on enlargement of an image.

FIG. 6 shows, in partially schematic form and according to at least some embodiments of the invention, update of an image file table based on editing of an image.

FIG. 7 shows, in partially schematic form and according to at least some embodiments of the invention, update of an image file table based on copying of an image to an album.

FIGS. 8-11 show, in partially schematic form and according to at least some embodiments of the invention, different thumbnail image displays based on different priority levels.

FIG. 12 shows, in partially schematic form and according to at least certain other embodiments of the invention, a thumbnail image display based on a specified priority level.

FIGS. 13 and 14 show examples of user interfaces for adjusting a priority threshold for display of thumbnail images.

### DETAILED DESCRIPTION OF THE PREFERRED EMBODIMENTS

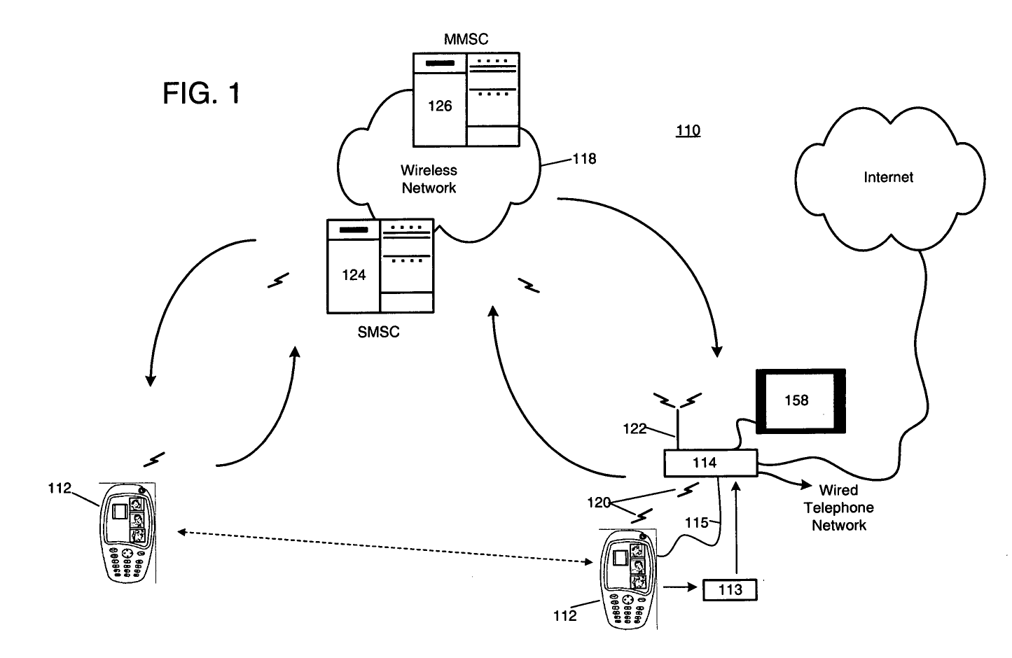

FIG. 1 shows an example of a wireless communication system 110 in which the systems and methods of the present invention may be advantageously employed. One or more network-enabled remote control devices or mobile devices 112, such as a personal digital assistant (PDA), digital camera, cellular phone, mobile terminal, or combinations thereof, is in communication with a server 114. Although not shown in FIG. 1, server 114 may act as a file server, such as a personal server or personal storage device, for a network such as home network, some other Local Area Network (LAN), or a Wide Area Network (WAN). Server 114 may be a computer or other device capable of storing and accessing data, such as a laptop, set-top box, DVD, television, PVR, DVR, TiVo device, personal portable server, personal portable media player, network server or other device capable of storing and accessing data, and which is coupled to a display device 158. Mobile device 112 may communicate with server 114 in a variety of manners; in at least some embodiments, a single mobile device 112 communicates with a server 114 in multiple manners. For example, mobile device 112 may communicate with server 114 via wireless network 118. Wireless network 118 may be a third-generation (3G) cellular data communications network, a Global System for Mobile communications network (GSM), or other wireless communication network.

Remote control device or mobile device 112 may also have one or more ports allowing a wired connection to server 114 via, e.g., universal serial bus (USB) cable 115. Mobile device 112 may also be capable of short-range wireless connection 120 (e.g., a BLUETOOTH, WLAN, WiFi or IrDA link) to server 114. A mobile personal server 113 may also be used. Personal server 113, which may be relatively small and/or more portable than server 114, provides additional storage capacity for images and other user data created with mobile device 112 (or created by other devices). In at least some embodiments, personal server 113 may be the same as the server 114, or may have some or all of the features of server 114 described below. Data may be periodically saved from mobile device 112 to personal server 113 via USB, BLUETOOTH or other type of link (shown collectively as an arrow from mobile device 112 to personal server 113). Data from personal server 113 may then be later downloaded to server 114 via USB, BLUETOOTH or other type of link (also shown collectively as an arrow).

Server 114 may act as a repository for storing files received from mobile device 112 and/or from other sources. Server 114 may have, or be coupled to, a wireless interface 122 configured to transmit communications (such as messages, files, or other data) to, and receive communications from, mobile network 118 or WLAN network. Server 114 may alternatively (or also) have one or more other communication network connections. For example, server 114 may be linked (directly or via one or more intermediate networks) to the Internet, to a conventional wired telephone system, or to some other communication or broadcast network, such as a TV, a radio, or IP datacasting network.

In one embodiment, mobile device 112 has a wireless interface configured to send and/or receive digital wireless communications within wireless network 118. As part of wireless network 118, one or more base stations (not shown) may support digital communications with mobile device 112 while the mobile device is located within the administrative domain of wireless network 118. The base station of wireless network 118 that is in communication with mobile device 112 may be the same or a different base station that is in communication with server 114. Indeed, mobile device 112 and server 114 may each be in communication with different wireless networks (e.g., mobile device 112 could be roaming), which could in turn be interlinked via one or more intermediate wired or wireless networks. For simplicity, server 114 and mobile device 112 are shown within the same wireless network 118.

Mobile device 112 communicates with server 114 via wireless network 118 and is configured to transmit user data for remote storage on server 114. As used herein, “user data” refers to information stored in a “user data file.” As previously discussed, a “user data file” includes, but is not limited to, video files (e.g., MPEG and other file types), audio files (e.g., MP3, MIDI, WAV and other file types), text files, message files (e.g., SMS and MMS messages), e-mails, HTML files, presentations, etc. Mobile device 112 may also be configured to access data previously stored on server 114. In one embodiment, file transfers between mobile device 112 and server 114 may occur via Short Message Service (SMS) messages and/or Multimedia Messaging Service (MMS) messages transmitted via short message service center (SMSC) 124 and/or a multimedia messaging service center (MMSC) 126. Although shown as part of network 118, SMSC 124 and MMSC 126 may be part of another network or otherwise outside of network 118. Although shown as separate logical entities, SMSC 124 and MMSC 126 could be a single entity. Further, SMSC 124 and MMSC 126 may coordinate via signaling between themselves for improving the file transfer process. For example, because SMSC 124 and MMSC 126 may be store-and-forward systems, rather than real-time systems, a file requested via an SMS message from mobile device 112 may still reside on MMSC 126 based upon a previous request. As such, SMSC 124 may copy MMSC 126 on an SMS file request and, if applicable, MMSC 126 may notify the user of the previously stored file. Further, MMSC 126 may simply transfer the requested file based on its stored copy of the file. In other embodiments, MMSC 126 may act as a repository for files, and mobile device 112 may simply request transfer of files from MMSC 126.

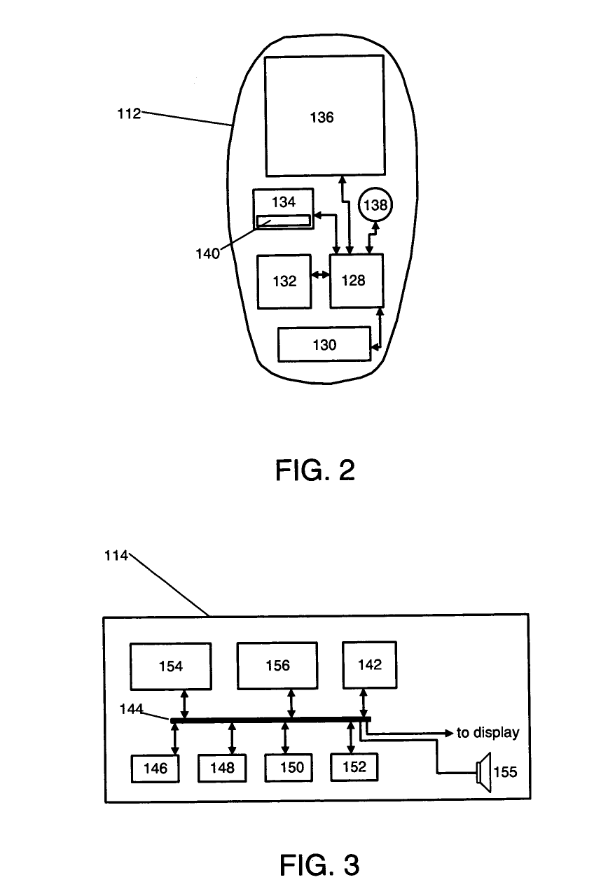

As shown in FIG. 2, mobile device 112 may include processor 128 connected to user interface 130, one or more wireless communications interface 132, such as cellular telephone connection or short-range wireless connection (such as Bluetooth, WLAN, WiFi or IrDA), memory 134 and/or other storage, display 136, and digital camera 138. User interface 130 may further include a keypad, four arrow keys, joy-stick, data glove, mouse, roller ball, touch screen, voice interface, or the like. Software 140 may be stored within memory 134 and/or other storage to provide instructions to processor 128 for enabling mobile device 112 to perform various functions. For example, software 140 may configure processor 128 to enable mobile device 112 to take digital photographs via digital camera 138, to automatically name a photograph, to save photographs as image files, to transfer image files to server 114, to retrieve and display image files from server 114, and to browse the Internet using communications interface 132. Software 140 may further configure processor 128 to enable mobile device 112 to create, store, play, send and/or receive audio, video, text and/or other types of user data files. Audio files (or audio portions of video files) are displayed by playing the file contents on a speaker within mobile device 112 (not shown) or on headphones (also not shown). Although not shown, communications interface 132 could include additional wired (e.g., USB) and/or wireless (e.g., BLUETOOTH, WLAN, WiFi or IrDA) interfaces configured to communicate over different communication links.

As shown in FIG. 3, server 114 may include processor 142 coupled via bus 144 to one or more communications interfaces 146, 148, 150 and 152. Interface 146 may be a cellular telephone or other wireless network communications interface. There may be multiple different wireless network communication interfaces. Interface 148 may be a conventional wired telephone system interface. Interface 150 may be a cable modem. Interface 152 may be a BLUETOOTH interface or any other short range wireless connection interface. Additionally, there may be multiple different interfaces. Server 114 may also include volatile memory 154 (e.g., RAM) and/or non-volatile memory 156 (such as a hard disk drive, tape system, or the like). Software and applications may be stored within memory 154 and/or memory 156 that provides instructions to processor 142 for enabling server 114 to perform various functions, such as processing file transfer requests (such as for image files), storing files in memory 154 or memory 156, displaying images and other data, and organizing images and other data. The other data may e.g. video files, audio files, emails, SMS/MMS messages, other message files, text files, presentations, etc. Although shown as part of server 114, memory 156 could be remote storage coupled to server 114, such as an external drive or another storage device in communication with server 114. Preferably, server 114 also includes or is coupled to a display device 158 (FIG. 1) via a video interface (not shown), which may or may not have a speaker for outputting audio. Display device 158 may be a computer monitor, a television set, an LCD projector, or other type of display device. In at least some embodiments, server 114 also includes a speaker 155 over which audio clips (or audio portions of video clips) stored in memory 154 or 156 may be played. In some other embodiments input device 112 and display 158, or alternatively input device 112, display device 158 and server 114, may be combined in a single device unit, such as a mobile phone, a digital camera, a digital audio device, etc.

A user accesses server 114 through a local input device, such as input device 112. Server 114 also displays various user interfaces (e.g., such as are described below) on display device 158 in addition to thumbnails, enlarged images, and other information. Possible input devices 112 include wired and wireless keyboards, mice and remote control units. Mobile device 112 could also function as a remote control unit and communicate with server 114 by BLUETOOTH or other wireless link, or via a cable connection to a port on mobile device 112. In such embodiments, various user interfaces (including the thumbnail views, slider bars and other interfaces described below) may be displayed on display 136, and files may be presented on mobile device 112 (e.g., images enlarged, video and audio clips played, text displayed, etc.). In some embodiments, server 114 is accessible remotely via mobile device 112 or (other devices) over wireless network 118, the Internet, or another communication network.

According to one embodiment of the invention, a method is provided for prioritizing files (i.e., assigning or modifying a file priority) stored on a device such as server 114, and for then displaying content of (or information about) those files based on those priorities. As used in this specification (including claims), “displaying” file content includes reproducing an audio file (on a speaker or other device) or the sound portion of a video or other file. A file type for which the file content has visual and sound components can be “displayed” if either a sound or visual component is reproduced. Although the following description refers to photographic image files received from one or more mobile devices 112, the invention is not limited by data type or source, nor by file type, format or source. In particular, embodiments of the invention include methods for prioritizing and/or displaying content/information for any type of user data file.

As images are created by mobile device 112, each image is stored as a data file in memory 134. Each image file is assigned a file name, and the files are ordered based on those assigned file names or based on the order in which the images are created. At some point, a user transfers those image files to server 114, where they are placed in storage memory 156. When initially transferred from mobile device 112 to server 114, image files are stored in the same order in which they were stored in memory 134 of mobile device 112. Other user data file types may be similarly named, ordered transferred and stored.

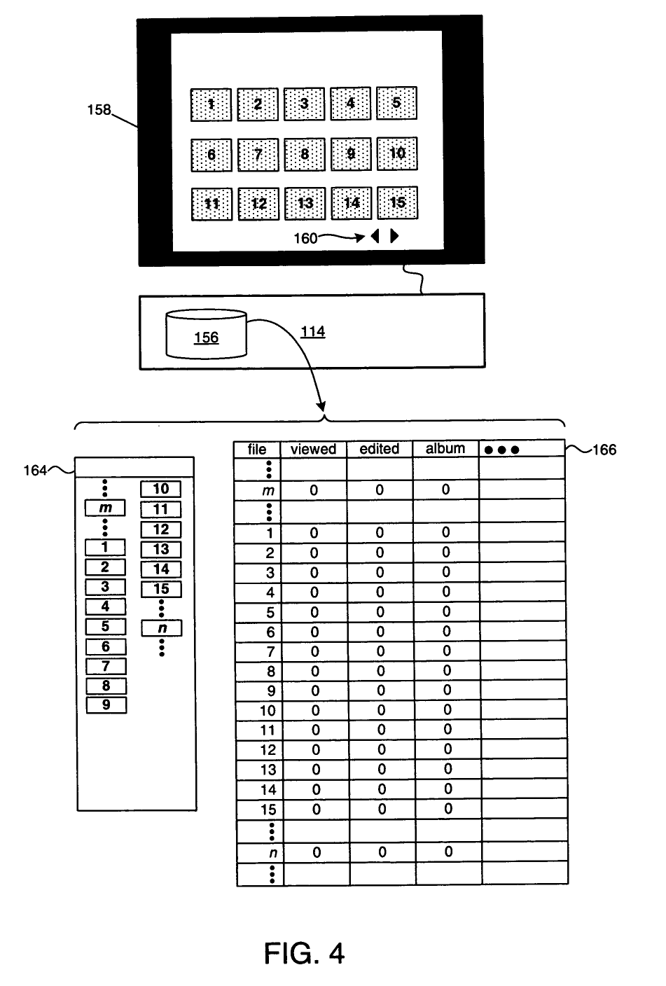

At some later point, a user then accesses images stored within storage memory 156. In at least some embodiments, the user is able to view multiple image files simultaneously as thumbnail images in a thumbnail view user interface. FIG. 4 shows, in partially schematic form, a thumbnail view interface on display 158. For simplicity, images are represented within the drawings as stippled and numbered boxes; an image file for a particular image is represented in the drawings as an unstippled box having the same number. As shown in FIG. 4, thumbnails of images or files 1 through 15 are arrayed on display 158 in chronological order, i.e. based on order of date/time of image creation. Additionally, thumbnails of images or files may be presented in a time-line manner, i.e. images or files related to specific periods or a moments of time are presented in own their specific groups, and the groups are presented in a time-line order, e.g. by date order. One or more groups in the time-line may be presented on the display simultaneously. Corresponding image files (which may be in JPEG or other format) are stored in storage memory 156 in one or more file folders 164. As shown in FIG. 4, only a limited number of thumbnails (fifteen in this example) are viewable on display 158 at one time. However, folder 164 contains numerous other image files, represented collectively as vertical ellipses above and below image files 1 and 15 (image file m represents an arbitrary image file preceding image file 1, and image file n represents an arbitrary image file following image file 15). “Page forward” and “page back” arrows 160 (or other appropriate interface) are provided in the thumbnail display so that the user may move forward (or backward) to additional screens (or pages) of thumbnail images. If the user selects the page back arrow, for example, thumbnail images for image files that chronologically precede file 1 are displayed. If the user selects the forward arrow, thumbnail images for image files that chronologically follow file 15 are displayed. Similarly, when presented in a time-line manner, arrows 160 may be used to scroll between groups in the time-line.

As also shown in FIG. 4, a table 166 having metadata information is associated with the image files in folder 164. Associated with each image file is a row having various metadata fields. A first field (“viewed”) holds a value corresponding to the number of times that image file has been enlarged for viewing (i.e., in a non-thumbnail view). In some embodiments, the “viewed” field (or a separate field) may also hold value(s) corresponding to the duration for which an image has been viewed. A second field (“edit”) holds a value representing whether (and/or, in some embodiments, the degree to which) the image file has been edited or manipulated. A third field (“album”) holds a value indicating whether the image has been copied to one or more albums. For example, a user may have grouped selected images from a particular event into a separate album (or folder) for that event, but not deleted those image files from folder 164. Such images would thus be accessible either by viewing the separate album, or by finding the images in a chronological thumbnail view of image files in folder 164. Although table 166 contains three named fields for each image file, numerous other fields (represented collectively as an ellipsis) could be added or substituted for the fields shown. For example, each image file could also have a field holding a value indicating which user of multiple users created the image file. As will be appreciated in light of the following explanation, such a field would permit each of multiple users to locate and view images that he or she created when images created by multiple users are stored in server 114. As another example, each image file could have a field holding a value based on the number of times that the image has been sent or received as an e-mail or as a file attachment to some other type of communication. Such a field could be used to locate and view thumbnails of images considered important enough to send to other persons. Still other examples include fields indicating whether the file has been annotated, whether there are “bookmarks” to the file from other sources, and/or whether the file contains links to other files. A field could be included for a manually input priority level assigned by a user. For video and audio files, a field could indicate whether the user has watched or listened to a portion of the file or to the entire file, and/or to the amount of the file that has been watched or to which the user has listened.

In alternate embodiments, file-specific fields may be separately implemented in each file. In still other embodiments, each file may only have a single priority value calculated from metadata of the type stored in table 166, and the underlying metadata used to calculate priority may not be saved.

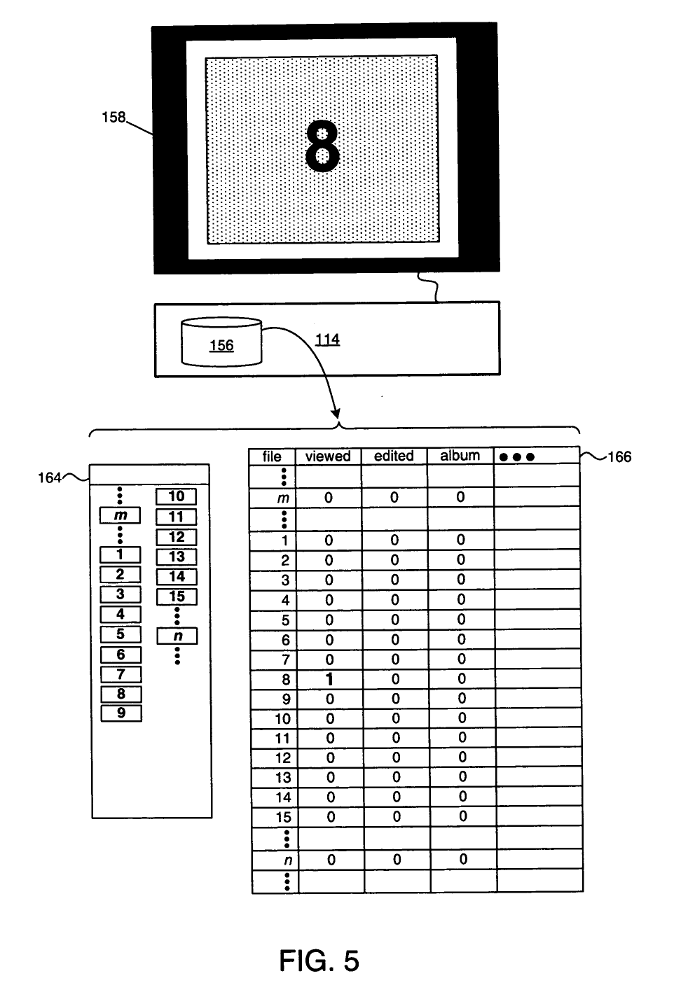

In FIG. 5, a user has selected a thumbnail image of interest (thumbnail 8), and the image is enlarged on display 158. When thumbnail image 8 is enlarged, processor 142 automatically updates the “viewed” field of image file 8 to indicate that the image has been selected by the user for enlarged viewing. In the embodiment of FIG. 5, the “viewed” field holds a value corresponding to a cumulative number of times the image has been enlarged. In other embodiments, the “viewed” field holds a graduated ranking based on how many times the image has been enlarged (e.g., “1” if enlarged between 1 and 3 times, “2” is enlarged between 4 and 10 times, “3” if enlarged more than 10 times). In still other embodiments, the viewed field simply holds a “0” if the image has never been enlarged and a “1” if the image has been enlarged (regardless of how many times).

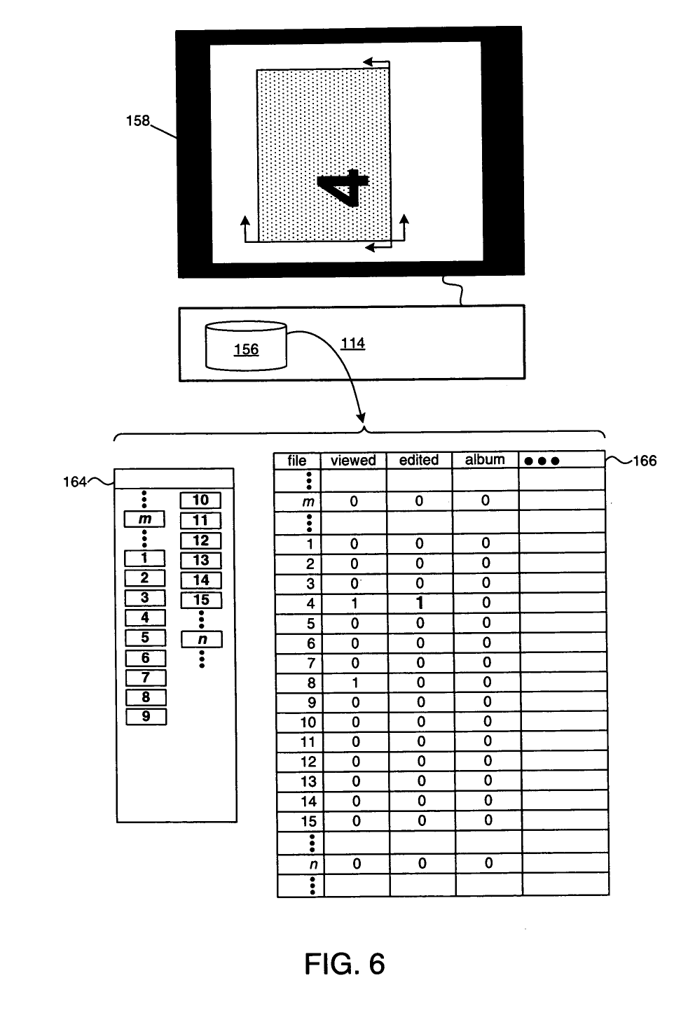

In FIG. 6, the user has next selected a thumbnail image 4 (thumbnail 4) for enlargement, and then edited and manipulated the enlarged image. In the example of FIG. 6, the user has rotated image 4 counterclockwise, and has cropped the rotated image from the bottom and right sides. As in FIG. 5, processor 142 automatically updates the “viewed” field for image file 4 to indicate that the image has been enlarged. In this case, however, processor 142 further updates the “edit” field based on the edits made to and the manipulation of the enlarged image. In the embodiment of FIG. 6, the “edit” field value is either “0” or “1”; the value is “0” if the image has never been edited or manipulated, and “1” if the image has been edited or manipulated (regardless of how many times or to what extent). In other embodiments, the “edit” field is updated with a value corresponding to the number of edits and/or manipulations. This may be a simple count, a graduated ranking based on the number of edits and/or manipulations, or some other value based on the number of edits and/or manipulations. In still other embodiments, the “edit” field value is updated based on the types of edits and/or manipulations. For example, if the image has been rotated (regardless of how many times), the “edit” field value is incremented by 1. If the image has been cropped (regardless of how many times), the “edit” field value is incremented by 2. Other types of actions could similarly cause incrementing of the “edit” field value. Of course, the “edit” field can be updated in numerous other manners based on the number and/or types of edits and/or manipulations. In some embodiments, “edit” field data is stored with regard to the original image file, while in other embodiments the “edit” and other field data is stored with regard to a separate file for the edited/manipulated image. In still other embodiments, the edit field data is stored with regard to the original image file and with regard to a separate file for the edited/manipulated image. In some embodiments, there are separate “edit” and “manipulated” fields for a file.

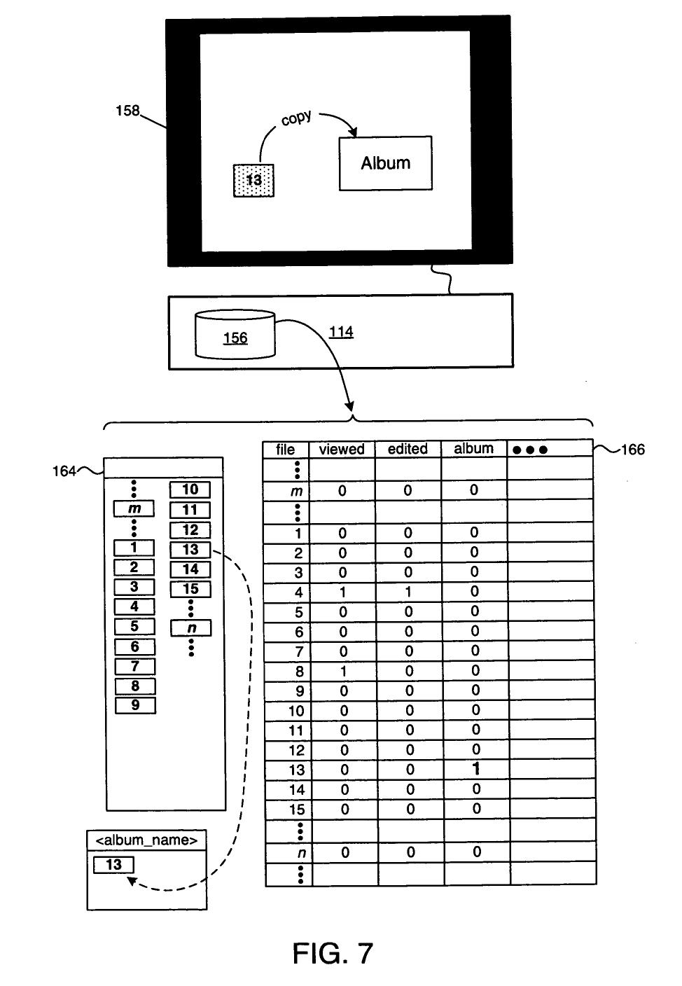

In FIG. 7, the user selects a thumbnail image (thumbnail 13) for copying to a separate folder (or “album”). As in FIGS. 5 and 6, processor 142 automatically updates the “album” field for image file 13 to indicate that the image has been copied to an album. In this case, the user has elected to copy image file 13 to the album without first enlarging the image. Accordingly, the “viewed” value is 0. If the user had first enlarged image 13 and then copied the image file to the album, the “viewed” field would have a value of 1. In the embodiment of FIG. 7, the “album” field value is either “0” or “1”; the value is “0” if the image has never been copied to an album, and “1” if the image has been copied to one or more albums. In other embodiments, the “album” field is updated with a value corresponding to the number of albums to which the image has been copied. This may either be a simple count of the number of albums, or a graduated ranking based on the number of albums. In the embodiment shown, the “album” field value remains the same even if the user later deletes the image from the album(s) to which it has been copied. In other embodiments, deletion of an image from an album causes update (e.g., decrementing) of the “album” field value for that image.

As the user (or users) enlarges, edits and/or copies additional images (whether in the same session or in multiple sessions), processor 142 makes similar updates to table 166. Using the data in table 166, processor 142 modifies the way in which thumbnails are displayed for image files in folder 164. Instead of displaying thumbnail images for all image files in folder 164, processor 142 only displays images meeting a designated priority threshold. In particular, processor 142 computes a priority for each image file based on the values in the “view,” “edit” and “album” fields for that image file. Based on the priorities for each image, processor 142 determines which image files to display as thumbnails.

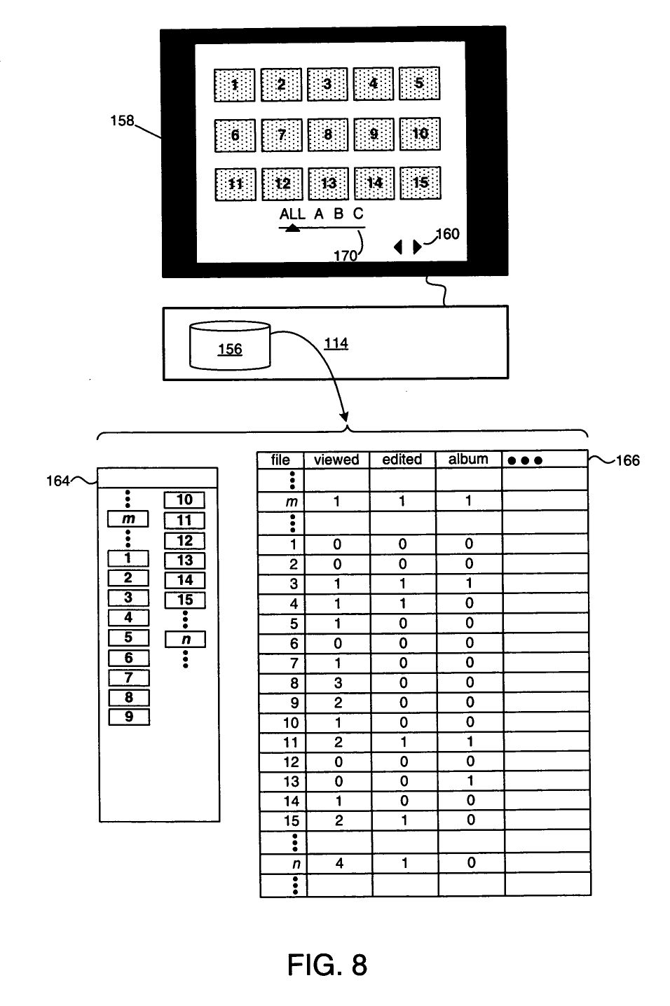

FIG. 8 shows table 166 after the user has enlarged, edited and copied additional image files. By providing desired priority level input using slider bar 170 or other appropriate user interface, the number of thumbnails displayed is limited based on the values in table 166. By selecting “ALL” (as shown in FIG. 8), thumbnails are shown for all image files in folder 164. In other words, the priority threshold is such that all image files meet the threshold, and the thumbnail image display is not adjusted based on the values in table 166. Additionally, the number of thumbnails displayed may also be filtered before or after providing the desired priority level. For example, the user could specify that thumbnail images having a particular priority level and a particular keyword (e.g., “summer” and “2003”, “family,” “mother,” etc.) as content or metadata should be displayed.

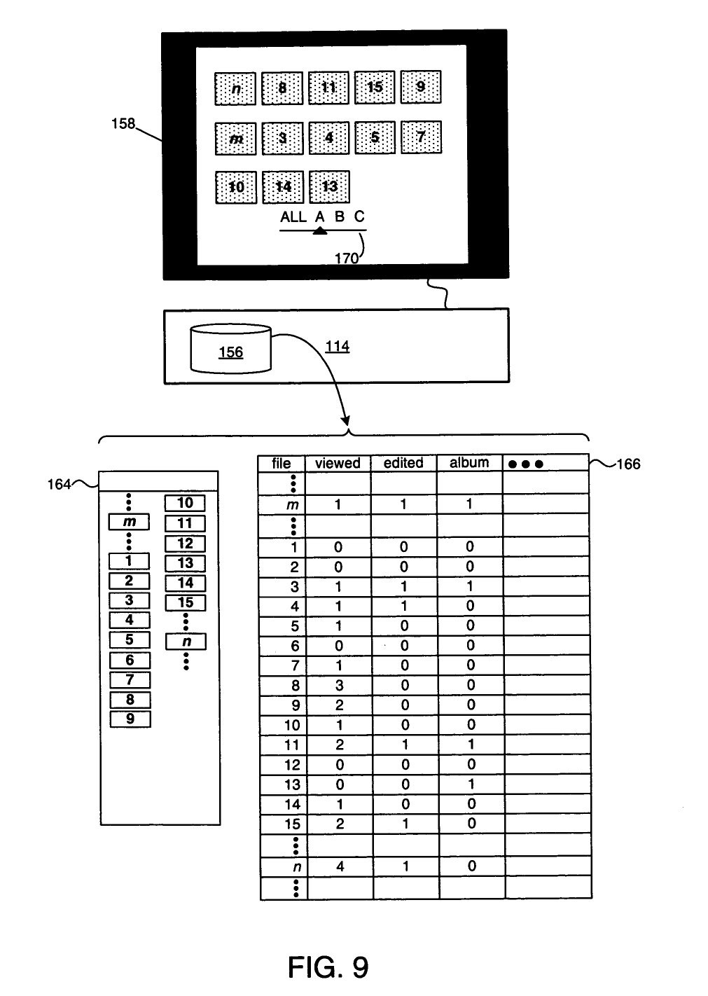

In FIG. 9, the user has selected priority level “A.” Based on this selection, processor 142 displays thumbnails for image files which have previously been enlarged, edited or copied. In other words, the priority threshold requires prior performance on a file of at least one of the specific actions. In at least some embodiments, and as shown in FIG. 9, the thumbnails shown for priority A are ordered based on the values of the “viewed” fields in the image files. For example, a thumbnail for an image file having a “viewed” value of 3 (thumbnail 8) is placed before thumbnails for image files having a “viewed” value of 1 (thumbnails m, 3, 4, 5, 7, 10 and 14). If several image files have the same “viewed” field value, thumbnails for those images are ordered chronologically. In other embodiments, all thumbnails shown for priority level A are ordered chronologically, or in some other manner.

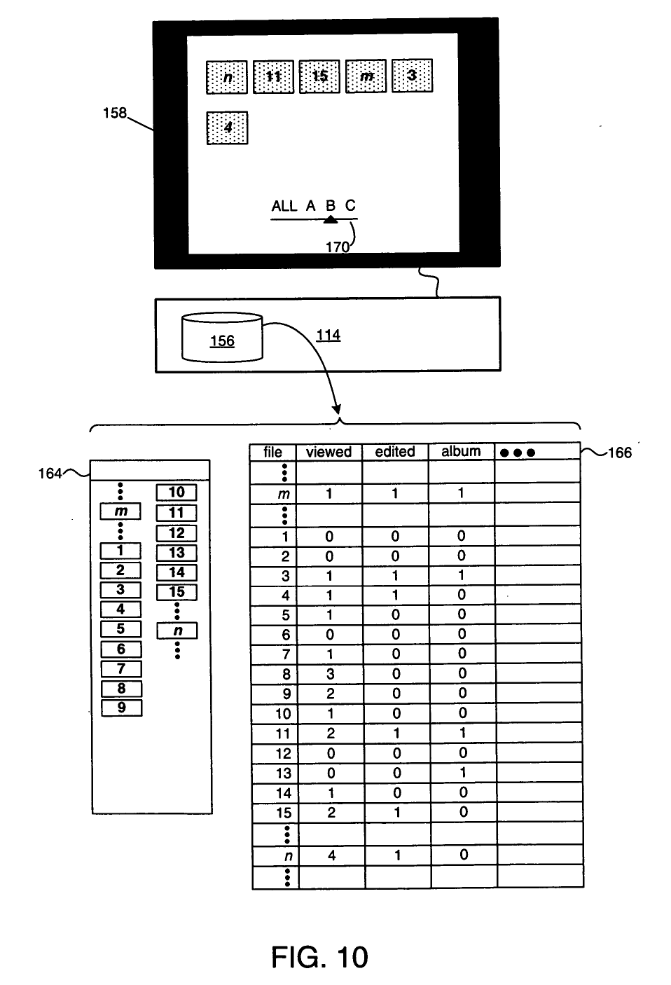

If the user selects priority level “B” (FIG. 10), processor 142 displays thumbnails for image files which have been enlarged and which have been edited. In other words, the priority threshold requires prior performance on a file of at least two specific actions. As in FIG. 9, the order in which thumbnails are arrayed is also dependent upon the values for the “viewed” fields of each corresponding image file. In other words, thumbnail images are ordered based on the number of times that the image has been enlarged. Where several images have the same values for the “viewed” field, thumbnails for those images are ordered chronologically. In embodiments where the “edit” field may have values in addition to 0 or 1, those additional values may be used for further ordering of thumbnails having the same “viewed” field value. In other embodiments, all thumbnails shown for priority level B are ordered chronologically, or in some other manner.

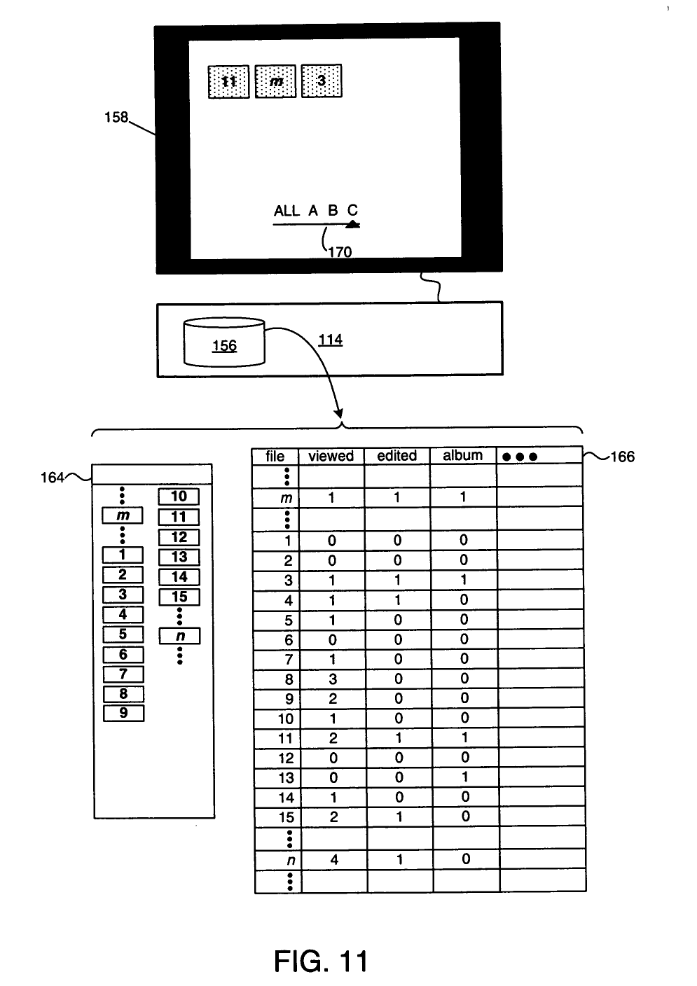

If the user selects priority level “C” (FIG. 11), processor 142 displays thumbnails for image files which have been enlarged, which have been edited and which have been copied to an album. In other words, the priority threshold now requires prior performance on a file of three specific actions. As in FIGS. 9 and 10, the order in which thumbnails are arrayed is also dependent upon the values for the “viewed” fields of each corresponding image file. Where several images have the same values for the “viewed” field, thumbnails for those images are ordered chronologically. In embodiments where the “album” field may have values in addition to 0 or 1, those additional values may be used for further ordering of thumbnails having the same “viewed” field values. In other embodiments, all thumbnails shown for priority level C are ordered chronologically, or in some other manner.

In the examples of FIGS. 8-11, selections “A,” “B” or “C” resulted in a thumbnail display that could be shown on one screen. This will not always be the case. In some cases (e.g., a large number of image files in folder 164), selection of “A,” “B” or “C” (or other user instruction to display less than all thumbnails) will reduce the number of thumbnails shown, but will still result in a multi-page display. However, the number of pages which the user must view (using, e.g., “page forward” or “page back” arrows 160) may be greatly reduced.

The preceding discussion of FIGS. 8-11 provides an example of an algorithm by which a display of thumbnails may be limited to less than all thumbnails in a particular group. As but another example, setting “B” in FIG. 10 could result in display of thumbnails for image files that have been enlarged and copied. As yet another possibility, setting “B” could cause display of thumbnails for image files that have been edited and copied. Other combinations of field values for a specific priority level are also within the scope of the invention, as are combinations of priority settings. For example, one priority level setting may specify images which have been enlarged, another may specify images which have been copied, and another may specify images which have been edited or otherwise manipulated. The user could then select any combination of these settings to, e.g., specify images which have been enlarged, images enlarged and copied, images enlarged and edited, etc. These and other prioritization algorithms and selection schemes are within the scope of the invention.

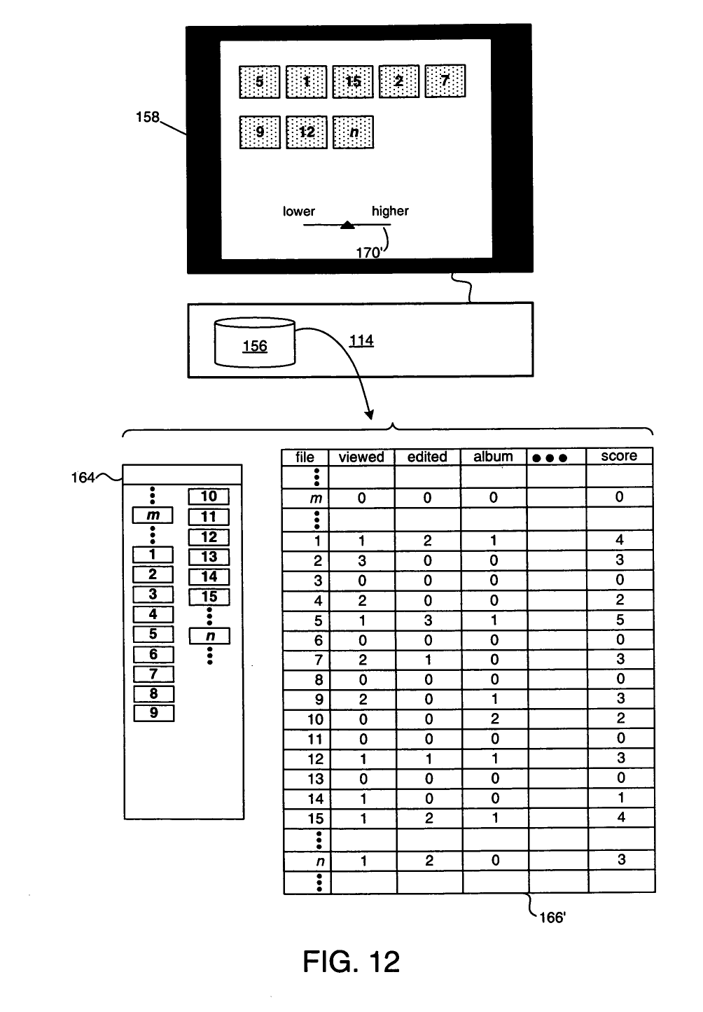

FIG. 12 is an example of another prioritization algorithm. In the embodiment of FIG. 12, the field values are summed for each image to yield a priority score for that image. Thumbnails are then displayed for images having a score above a user-defined threshold. In at least one embodiment, values for the fields of table 166′ are set in accordance with Table 1.

TABLE 1

| | value = | value = | value = | value = |
|---|---|---|---|---|
| field | 0 if: | 1 if: | 2 if: | 3 if: |
| “view” | not | enlarged | enlarged | enlarged |
| | previously | between | between | more than |
| | enlarged | 1 and 2 | 3 and 5 | 5 times |
| | | times | times | |
| “edit” | not | edited 1 | edited 2 | edited 3 |
| | previously | time | times | or more |
| | edited | | | times |
| “album” | not copied | copied to | copied to | copied to |
| | | 1 album | 2 albums | 3 or more |
| | | | | albums |

If an image has not been enlarged, the “view” value for that image is 0. If the image has been enlarged once or twice, the “view” value is 1. If the image has been enlarged between 3 and 5 times, the “view” value is 2. If the image has been enlarged more than 5 times, the view value is 3. The values for the “edit” and “album” fields are similarly determined in accordance with Table 1.

By manipulating on-screen slider bar 170′ in FIG. 12, a user sets the priority threshold for images to be displayed as thumbnails. Moving the slider in one direction (“lower”) decreases the threshold, while moving in another direction (“higher) increases the threshold. In FIG. 12, the setting of slider 170′ corresponds to a priority threshold of three. In other words, image files having a priority score of three or more are displayed as thumbnails, while image files have a priority score less then three are not displayed as thumbnails. Notably, an image file not shown as a thumbnail (image file 4) has been enlarged more times than several image files that are shown as thumbnails (image files 1, 5, 12, 15 and n). As can be appreciated, the embodiment of FIG. 12 recognizes that a particular image may not have been enlarged as frequently as other image files, but nonetheless be very important. In the embodiment of FIG. 12, the displayed thumbnails are ordered based on the respective priority scores of the corresponding image files. Thumbnails having corresponding image files with identical priority scores are ordered chronologically. In other embodiments, all thumbnails are ordered chronologically, or in some other manner.

In yet another embodiment, user data files which are not presented, edited, or manipulated during a first, second, or third (or more) reviewing session may be deleted, removed, or hidden from collection folder 164. The selection of user data files may be based on a threshold value. Selecting user data files based on a threshold value allows a user to define a permanent view that presents only relevant data files. Deleted, removed, or hidden data files may be either restored or presented by a user selected command.

In yet another embodiment, a value is calculated for a manipulated user data file and added to a sum of priority data for the manipulated data file. In a system and method according to this embodiment, a user data file having priority data is selected to be presented, edited, or manipulated. The value of priority data may be zero or empty (i.e. NULL) if the file has not yet been presented, edited or manipulated, or it may already have a value if the file has already been presented, edited or manipulated. The data file manipulation file value is calculated based on how the file is presented, edited, or manipulated. In providing this calculation, table 1 or any other table describing values and multipliers of different types of presentations, edits or manipulations may be used. After the calculation is completed, the value of the manipulation is added to the value of the priority data for the user data file. The sum may then be used for presenting user data files or information about the user data files in a prioritized manner.

Referring back to FIG. 1, an embodiment is shown in which the data files are stored in a portable personal server 114. In yet another embodiment, the data files may be stored in a network server, which may include a service by a service provider. According to an aspect of the invention, a user may access the server and present, edit or manipulate the data files using a mobile communication device (or a wireline communication device like a PC computer) in the same manner as described throughout this specification. The network server may receive the data files from the mobile communication device (or from the PC computer) or from any other source, such as a photo service provider, or a music or video service provider. Users may access the server and service through the mobile communication device via a wireless network, such as wireless telecom network, or a short range wireless network, such as WLAN, Bluetooth etc. Commands for presenting, manipulating and editing the data files may be transmitted through the network. Data files may be retrieved for presentation through the network where a display is provided by the user's mobile communication device. Alternatively, if the display is external to the user's mobile communication device, such as a TV device, set-top box, or personal computer, the selected data files may directed to the display device through a second wireless or wireline communication network, such as a wireless telecom network, or a short range wireless network, such as WLAN, Bluetooth etc.

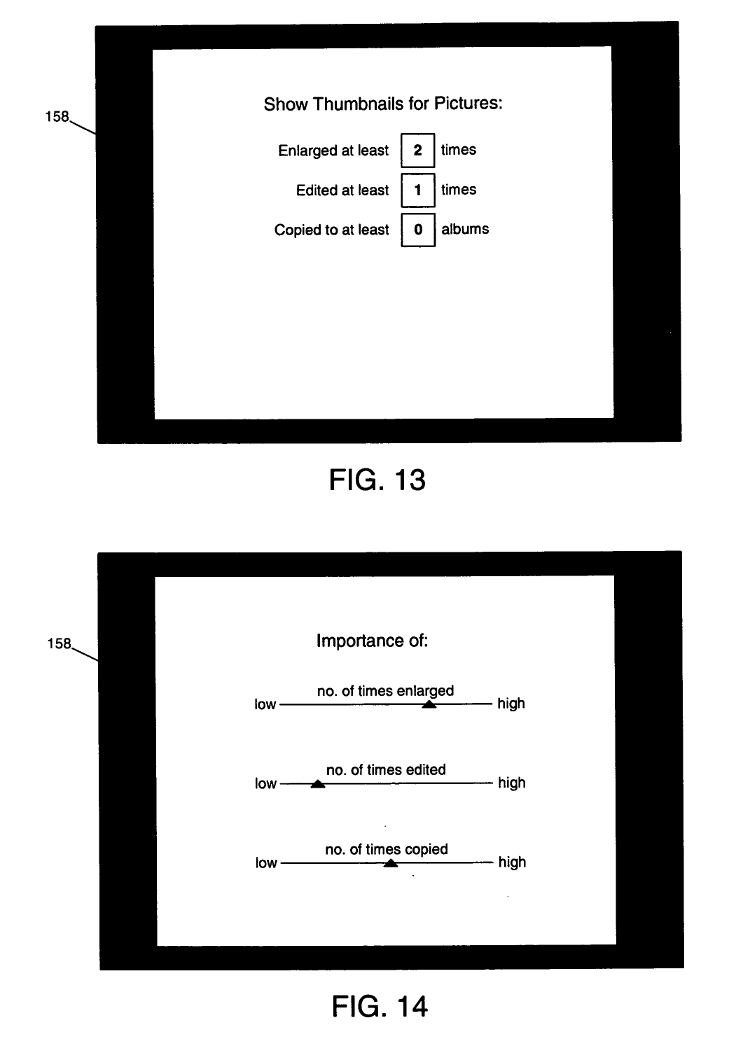

In additional embodiments, a user is provided more control over the thumbnails to be included in a thumbnail view. For example, a user interface such as is shown in FIG. 13 permits a user to specify that thumbnail images are to be displayed for image files enlarged, edited and/or copied a certain number of times. If, for example, the user wishes to see thumbnails for image files enlarged 3 or more times (regardless of whether a file has been edited or copied to an album), the user could set the “enlarged at least” value to 3, and the other values to 0. As another example, the user could set the “enlarged at least” value to 3, the “edited at least” value to 1, and the “copied to at least” value to 1 if the user only wishes to see thumbnails for image files that have been enlarged 3 or more times, edited 1 or more times and copied to at least one album. As shown in FIG. 14, some or all of these settings could alternately be adjusted using a slider bar or other appropriate interface.

FIGS. 4-12 schematically show tables 166 and 166′ stored separately from the image files in folder 164. Accordingly, when the individual image files in folder 164 are enlarged, edited, etc., table 166 or table 166′ is separately (and automatically) accessed and an appropriate field updated. In other embodiments, the data contained within table 166 or table 166′ is stored in a different manner. For example, the attributes shown in the various fields can be added to each of the individual image files as metadata. When determining which of the image files to display in a thumbnail view, those attributes are accessed by the thumbnail viewer software, and the appropriate image files selected. In still other embodiments, explicit values are not assigned to files; files are instead prioritized by adjusting the locations of each file within a group of files, and/or by adjusting the locations of file names within a listing of file names. When determining which files to display in a thumbnail view, files above (or below, preceding, after, etc.) a specified location in the file group or file list are identified.

As can be appreciated from the preceding description, embodiments of the invention allow a user to locate electronic images in a convenient manner. As previously indicated, the invention is not limited to data for still images. Although the above description and FIGS. 4-14 use still images as examples, the invention is equally applicable to other types of user data files. In the case of video clips, the thumbnail images could be of the first frame of the clip. Upon selecting a video thumbnail, the video clip is played in an enlarged view. Playing a video clip file in an enlarged view, editing the file and/or copying the file to an album causes automatic update of appropriate fields in a table. Other aspects of the embodiments described above are similarly applicable. Alternatively (and in the case of audio clips), the user can be presented with a display of icons or a simple list of file names as the “thumbnail” view. Selecting a file name or icon would then cause the corresponding image, video or audio file to be enlarged (or played), with other features of the previously-described embodiments being similarly applicable. In the case of text files and other types of files, a “thumbnail view” could provide a miniaturized representation of each file's contents or a portion thereof (e.g., the first page for multipage files), could be a listing of files, or could be some other type of display providing information about the files. Indeed, the invention is not limited to providing information about prioritized files in a thumbnail view or other file selection user interface. In some embodiments, for example, information regarding files having a priority above a priority threshold is provided in another manner (e.g., a seriatim display of file contents for files having above-threshold priorities).

Although specific examples of carrying out the invention have been described, those skilled in the art will appreciate that there are numerous variations and permutations of the above-described systems and methods that are contained within the spirit and scope of the invention as set forth in the appended claims. For example, the algorithms, user interfaces and screen layouts described are only examples; other algorithms, user interfaces and screen layouts are within the scope of the invention. Instead of only displaying information about files having a priority above a specified threshold, certain embodiments display information about files with priorities above and below the threshold, but with the files having above-threshold priorities indicated in some way (e.g., flagged with an icon, placed at the beginning of a list, etc.). In certain embodiment the invention may display information about files having a priority below a specified threshold instead of displaying information about files having a specified threshold above a specified threshold. Images need not be created with a mobile device capable of communication via long-range wireless transmission. For example, images could be created by a digital camera which must download images by USB or BLUETOOTH connection or by transfer to a removable medium, or by scanning a previously-created drawing, photograph or other document. As yet a further alternative, a machine-readable medium could have machine-executable instructions stored thereon such that, when the instructions are read and executed by an appropriate device (or devices), steps of a method according to the invention are performed. These and other modifications are within the scope of the invention as defined in the attached claims. In the claims, various portions of the claims are prefaced with parenthetical letter or number references for convenience. However, use of such references does not imply a temporal relationship not otherwise required by the language of the claims.

We claim:

1. A method for providing user data files based on file priorities, comprising:
(a) storing a plurality of user data files in a memory, each of the user data files having a priority;
(b) performing one or more file actions with regard to one or more user data files of the plurality;
(c) modifying the priorities of the one or more user data files of the plurality in response to performance of the one or more file actions;
(d) receiving a designation of a priority threshold;
(e) determining which user data files of the plurality have a priority above the priority threshold; and
(f) providing user data files of the plurality having a priority above the priority threshold.

2. The method of claim 1, wherein step (f) comprises providing information about the user data files.

3. The method of claim 1, wherein step (f) comprises presenting the user data files.

4. The method of claim 1, wherein the user data files comprise at least one of image files, video files and audio files.

5. The method of claim 1, wherein step (f) comprises displaying a file selection user interface providing information about user data files of the plurality having a priority above the priority threshold, said interface not providing information about user data files of the plurality having a priority below the priority threshold.

6. The method of claim 1, wherein step (f) comprises ordering at least some user data files of the plurality based on the respective priorities of said at least some user data files.

7. The method of claim 4, wherein step (f) further comprises not providing information about user data files of the plurality having a priority below the priority threshold.

8. The method of claim 1, further comprising:
(g) storing user data files of the plurality having a priority above the priority threshold in a separate folder.

9. The method of claim 1, wherein the one or more file actions comprise at least one of the following:
(1) displaying the contents of a user data file,
(2) editing the contents of a user data file,
(3) manipulating the contents of a user data file,
(4) copying a user data file subsequent to initial storage of said user data file in the memory,
(5) transmitting a copy of a user data file,
(6) annotating a user data file, and
(7) associating a user data file with a specific user.

10. The method of claim 9, wherein:
step (e) comprises identifying user data files of the plurality previously the subject of at least one of file actions (1) through (7).

11. The method of claim 9, wherein:
step (e) comprises identifying user data files of the plurality previously the subject of at least two of file actions (1) through (7).

12. The method of claim 9, wherein:
step (e) comprises identifying user data files of the plurality previously the subject of more than two of file actions (1) through (7).

13. The method of claim 9, wherein:
step (d) comprises displaying a user interface having choices corresponding to at least three priority thresholds, wherein:
a first priority threshold comprises no prior performance of any of file actions (1) through (7) upon a file,
a second priority threshold comprises prior performance of at least one of file actions (1) through (7) upon a file, and
a third priority threshold comprises prior performance of at least two of file actions (1) through (7) upon a file.

14. The method of claim 1, wherein:
the priority of each file comprises a history of file actions performed on the file, and
the priority threshold comprises performance of a minimum number of prior file actions with respect to a file.

15. The method of claim 1, further comprising:
(g) displaying a user interface for setting the priority threshold, the user interface receiving user designation of a minimum number of each of multiple types of file actions.

16. The method of claim 1, wherein:
the priority of each file comprises a score based on multiple components,
each component of a score corresponds to a type of file action and has a value based on performance of the corresponding action upon the file, and
at least one of the components can have at least three possible values.

17. The method of claim 1, wherein:
the plurality of user data files are electronic image files, and
step (f) comprises displaying a file selection user interface providing thumbnail images for user data files of the plurality having a priority above the priority threshold, said interface not providing thumbnail images for user data files of the plurality having a priority below the priority threshold.

18. The method of claim 1, further comprising:
(g) receiving the plurality of user data files from a mobile device communicating user data files over a wireless communication network to a server performing steps (a) through (e).

19. The method of claim 1, wherein:
a server performs at least steps (a), (c), (d) and (e), and
step (f) is performed at least in part on a mobile device capable of wireless communication with the server.

20. The method of claim 19, wherein the mobile device is in communication with the server via at least one of a short-range wireless connection, a wireless network connection and a wired connection.

21. A machine-readable medium having machine-executable instructions for performing steps of a method for providing user data files based on file priorities, the steps comprising:
(a) storing a plurality of user data files in a memory, each of the user data files having a priority;
(b) performing one or more file actions with regard to one or more user data files of the plurality;
(c) modifying the priorities of the one or more user data files of the plurality in response to performance of the one or more file actions;
(d) receiving a designation of a priority threshold;
(e) determining which user data files of the plurality have a priority above the priority threshold; and
(f) providing user data files of the plurality having a priority above the priority threshold.

22. The method of claim 21, wherein step (f) comprises providing information about the user data files.

23. The method of claim 21, wherein step (f) comprises presenting the user data files.

24. The machine-readable medium of claim 21, wherein the user data files comprise at least one of image files, video files and audio files.

25. The machine-readable medium of claim 21, wherein step (f) comprises displaying a file selection user interface providing information about user data files of the plurality having a priority above the priority threshold, said interface not providing information about user data files of the plurality having a priority below the priority threshold.

26. The machine-readable medium of claim 21, wherein step (f) comprises ordering at least some user data files of the plurality based on the respective priorities of said at least some user data files.

27. The machine-readable medium of claim 26, wherein step (f) further comprises not providing information about user data files of the plurality having a priority below the priority threshold.

28. The machine-readable medium of claim 21, comprising additional instructions for performing steps comprising:
(g) storing user data files of the plurality having a priority above the priority threshold in a separate folder.

29. The machine-readable medium of claim 21, wherein the one or more file actions comprise at least one of the following:
(1) displaying the contents of a user data file,
(2) editing the contents of a user data file,
(3) manipulating the contents of a user data file,
(4) copying a user data file subsequent to initial storage of said user data file in the memory,
(5) transmitting a copy of a user data file,
(6) annotating a user data file, and
(7) associating a user data file with a specific user.

30. The machine-readable medium of claim 29, wherein:
step (e) comprises identifying user data files of the plurality previously the subject of at least one of file actions (1) through (7).

31. The machine-readable medium of claim 29, wherein:
step (e) comprises identifying user data files of the plurality previously the subject of at least two of file actions (1) through (7).

32. The machine-readable medium of claim 29, wherein:
step (e) comprises identifying user data files of the plurality previously the subject of more than two of file actions (1) through (7).

33. The machine-readable medium of claim 29, wherein:
step (d) comprises displaying a user interface having choices corresponding to at least three priority thresholds, wherein:
a first priority threshold comprises no prior performance of any of file actions (1) through (7) upon a file,
a second priority threshold comprises prior performance of at least one of file actions (1) through (7) upon a file, and
a third priority threshold comprises prior performance of at least two of file actions (1) through (7) upon a file.

34. The machine-readable medium of claim 21, wherein:
the priority of each file comprises a history of file actions performed on the file, and
the priority threshold comprises performance of a minimum number of prior file actions with respect to a file.

35. The machine-readable medium of claim 21, comprising additional instructions for performing steps comprising:
(g) displaying a user interface for setting the priority threshold, the user interface receiving user designation of a minimum number of each of multiple types of file actions.

36. The machine-readable medium of claim 21, wherein:
the priority of each file comprises a score based on multiple components,
each component of a score corresponds to a type of file action and has a value based on performance of the corresponding action upon the file, and
at least one of the components can have at least three possible values.

37. The machine-readable medium of claim 21, wherein:
the plurality of user data files are electronic image files, and
step (f) comprises displaying a file selection user interface providing thumbnail images for user data files of the plurality having a priority above the priority threshold, said interface not providing thumbnail images for user data files of the plurality having a priority below the priority threshold.

38. The machine-readable medium of claim 21, comprising additional instructions for performing steps comprising:
(g) receiving the plurality of user data files from a mobile device communicating user data files over a wireless communication network to a server performing steps (a) through (e).

39. The machine-readable medium of claim 21, wherein:
a server performs at least steps (a), (c), (d) and (e), and
step (f) is performed at least in part on a mobile device capable of wireless communication with the server.

40. The machine-readable medium of claim 39, wherein the mobile device is in communication with the server via at least one of a short-range wireless connection, a wireless network connection and a wired connection.

41. A device for storing user data files, comprising:
a memory;
a processor configured to perform steps for providing user data files based on file priorities, the steps comprising:
(a) storing a plurality of user data files in the memory, each of the user data files having a priority,
(b) performing one or more file actions with regard to one or more user data files of the plurality,
(c) modifying the priorities of the one or more user data files of the plurality in response to performance of the one or more file actions,
(d) receiving a designation of a priority threshold,
(e) determining which user data files of the plurality have a priority above the priority threshold, and
(f) providing user data files of the plurality having a priority above the priority threshold.

42. The device of claim 41, wherein step (f) comprises providing information about the user data files.

43. The device of claim 41, wherein step (f) comprises presenting the user data files.

44. The device of claim 41, wherein the device is one of following: a server, a set-top box, a TV and a personal computer.

45. The device of claim 41, comprising a first communications interface through which user transmits one or more commands to the device.

46. The device of claim 45, wherein one or more of commands are the file actions.

47. The device of claim 45, wherein one or more of the commands is the priority threshold.

48. The device of claim 41, comprising a first user interface through which user inputs one or more commands to the device.

49. The device of claim 41, comprising a second communications interface through which user data files may be transferred to the memory.

50. The device of claim 41, wherein the user data files comprise at least one of image files, video files and audio files.

51. The device of claim 41, wherein step (f) comprises displaying a file selection user interface providing information about user data files of the plurality having a priority above the priority threshold, said interface not providing information about user data files of the plurality having a priority below the priority threshold.

52. The device of claim 41, wherein step (f) comprises ordering at least some user data files of the plurality based on the respective priorities of said at least some user data files.

53. The device of claim 52, wherein step (f) further comprises not providing information about user data files of the plurality having a priority below the priority threshold.

54. The device of claim 41, wherein the processor is further configured to perform steps comprising:
(g) storing user data files of the plurality having a priority above the priority threshold in a separate folder.

55. The device of claim 41, wherein the one or more file actions comprise at least one of the following:
(1) displaying the contents of a user data file,
(2) editing the contents of a user data file,
(3) manipulating the contents of a user data file,
(4) copying a user data file subsequent to initial storage of said user data file in the memory,
(5) transmitting a copy of a user data file,
(6) annotating a user data file, and
(7) associating a user data file with a specific user.

56. The device of claim 55, wherein:
step (e) comprises identifying user data files of the plurality previously the subject of at least one of file actions (1) through (7).

57. The device of claim 55, wherein:
step (e) comprises identifying user data files of the plurality previously the subject of at least two of file actions (1) through (7).

58. The device of claim 55, wherein:
step (e) comprises identifying user data files of the plurality previously the subject of more than two of file actions (1) through (7).

59. The device of claim 55, wherein:
step (d) comprises displaying a user interface having choices corresponding to at least three priority thresholds, wherein:
a first priority threshold comprises no prior performance of any of file actions (1) through (7) upon a file,
a second priority threshold comprises prior performance of at least one of file actions (1) through (7) upon a file, and
a third priority threshold comprises prior performance of at least two of file actions (1) through (7) upon a file.

60. The device of claim 41, wherein:
the priority of each file comprises a history of file actions performed on the file, and
the priority threshold comprises performance of a minimum number of prior file actions with respect to a file.

61. The device of claim 41, wherein the processor is further configured to perform steps comprising:
(g) displaying a user interface for setting the priority threshold, the user interface receiving user designation of a minimum number of each of multiple types of file actions.

62. The device of claim 41, wherein:
the priority of each file comprises a score based on multiple components,
each component of a score corresponds to a type of file action and has a value based on performance of the corresponding action upon the file, and
at least one of the components can have at least three possible values.

63. The device of claim 41, wherein:
the plurality of user data files are electronic image files, and
step (f) comprises displaying a file selection user interface providing thumbnail images for user data files of the plurality having a priority above the priority threshold, said interface not providing thumbnail images for user data files of the plurality having a priority below the priority threshold.

64. The device of claim 41, wherein the processor is further configured to perform steps comprising:
(g) receiving the plurality of user data files from a mobile device via the communications interface.

65. A system for generating a file selection user interface, comprising:
a wireless mobile device, including:
a digital camera,
a memory for storing image files for images created with the digital camera, and
a communication interface with a wireless communication network for transmission of image files stored in the memory; and
a server, including:
a communications interface through which image files are received from the wireless mobile device via the wireless communication network,
a server memory for storing image files received through the communications interface, and
a processor configured to perform steps comprising:
(a) storing a plurality of image files in the server memory, each of the image files having a priority comprising a history of file actions performed on the file, each of the image files containing an electronic image,
(b) automatically modifying priorities of image files of the plurality in response to performance of file actions, wherein the file actions include:
(1) displaying an image file by generating an enlarged view of the image contained in the file,
(2) modifying an image file, and
(3) copying an image file subsequent to initial storage of said image file in the server memory,
(c) displaying a user interface having selections corresponding to at least four priority thresholds, wherein:
a priority threshold comprises performance of a minimum amount of prior file actions with respect to an image file,
a first designatable priority threshold comprises no prior performance of any of file actions (1) through (3) upon an image file,
a second designatable priority threshold comprises prior performance of at least one of file actions (1) through (3) upon an image file,
a third designatable priority threshold comprises prior performance of at least two of file actions (1) through (3) upon an image file, and
a fourth designatable priority threshold comprises prior performance of each of file actions (1) through (3) upon an image file,
(d) receiving a designation of one of the first, second, third or fourth priority thresholds,
(e) automatically determining which image files of the plurality have a priority above the designated priority threshold, and
(f) displaying a thumbnail view interface providing thumbnail images for image files of the plurality having a priority above the designated priority threshold, said interface not providing thumbnail images for image files of the plurality having a priority below the designated priority threshold, wherein the thumbnail images are ordered based on the respective priorities of the image files of the plurality having a priority above the designated priority threshold.

66. A method for providing in a first network user data files based on file priorities, comprising:
(a) receiving a plurality of user data files in a memory of a network server, each of the user data files having a priority;
(b) receiving from the first network, commands for performing one or more file actions with regard to one or more user data files of the plurality;
(c) modifying the priorities of the one or more user data files of the plurality in response to performance of the one or more file actions;
(d) receiving a designation of a priority threshold;
(e) determining which user data files of the plurality have a priority above the priority threshold; and
(f) transmitting through the first network user data files of the plurality having a priority above the priority threshold.

67. The method of claim 66, wherein the commands for performing one or more file actions are received from a mobile communication device connected to the network server.

68. The method of claim 67, further comprising:
(g) receiving by the mobile communication device the transmitted user data files.

69. The method of claim 68 further comprising:
(h) displaying the received user data files in a display.

70. The method of claim 69, wherein the display is provided by the mobile communication device.

71. The method of claim 69 further comprising:
(i) if the display is external to the mobile communication device, connecting the mobile communication device to the display;
(j) transmitting the received user data files from the mobile communication device to the display; and
(k) displaying the received user data files on the display.

72. The method of claim 71, wherein the display external to the mobile communication device is connected to the mobile communication device via a wireless network connection.

73. The method of claim 72, wherein the wireless network connection is one of a WLAN, or a Bluetooth connection.

74. The method of claim 71 wherein the wireless network connection is part of a second network separate from the first network.

75. The method of claim 66, wherein the received user data files from step (a) are provided by one of a photo service provider, a music service provided, or a video service provider.
